(19) United States
(12) Patent Application Publication
(10) Pub. No.: US 2008/0162170 A1
(43) Pub. Date: Jul. 3, 2008

(54) METHOD AND SYSTEM FOR DIGITAL RIGHTS MANAGEMENT BASED ON MESSAGE EXCHANGE BETWEEN DRM AGENT AND RENDERING

(75) Inventors: Deepak Kumar, Bangalore (IN); Perumal Raj, Bangalore (IN); Weon Il Jin, Sunwon-si (KR); Rakesh Gupta, Bangalore (IN)

Correspondence Address: DLA PIPER US LLP, P. O. BOX 9271, RESTON, VA, 20195, US

(73) Assignee: SAMSUNG ELECTRONICS CO., LTD, SUWON-SI (KR)

(21) Appl. No.: 11/856,834

(22) Filed: Sep. 18, 2007

(30) Foreign Application Priority Data
Dec. 29, 2006 (KR) 10-2006-0138719

(51) Int. Cl. G06Q 10/00

(52) U.S. Cl. 705/1

(57) ABSTRACT

A method and system of Digital Rights Management (DRM) in a consumer environment where the DRM agent and the rendering application are implemented on separate devices is provided. A first control message is transmitted from the rendering application to notify the DRM agent about the details of a content consumption pattern. The DRM agent receives the first control message, and determines whether the consumption operation detailed in the first control message is a permitted operation. The DRM agent responds with a second control message that either indicates that the operation is permitted or indicates that the operation is not permitted. The rendering application in response to the second control message either halts the consumption operation or if the operation is allowed, performs the consumption operation.

### CROSS-REFERENCE TO RELATED APPLICATION

This application claims the benefit under 35 U.S.C. §119(a) of a Korean Patent Application No. 10-2006-0138719, filed on Dec. 29, 2006 in the Korean Intellectual Property Office, the entire disclosure of which is hereby incorporated by reference.

### BACKGROUND OF THE INVENTION

1. Field of the Invention

The present invention relates to a method for, and system of, Digital Rights Management (DRM) in an environment in which a DRM agent and a rendering application are implemented on separate devices.

2. Description of Related Art

Digital Rights Management (DRM) generally and broadly encompasses any measure for controlling and/or limiting the unfettered use and/or disposition of informational and/or entertainment contents, such as, for example, documents, news articles, magazines, musical recordings, movie titles, books, games, software, or the like, that are distributed in digital form (stop “digital content”). The desire for such control is based in large part on the desire to protect the proprietary, privacy and/or economic interest of the owner and/or the author of the digital content. Under a DRM regime, a digital content is provided by a content provider, typically over one or more of various communications networks, e.g., the Internet, the world-wide-web, cellular phone network, intranet, or the like., to a consumer device, for example, such as a personal computer (PC), a personal digital assistant (PDA), a portable music/video player, a cellular phone device, or the like, that includes an application for rendering the digital content (“rendering application”). The rendering application may take the form of a software program, hardware, or any combination thereof, and presents the digital content received from the content provider on the consumer device in a useable or intelligible form for the user of the consumer device.

A DRM infrastructure may manifest one of many varying levels of complexity, which may range from, in the simplest form, an encryption and/or scrambling of the protected content to the more elaborate scheme of specifying and/or administering of usage rules or policies that may define, e.g., the permission for copying and/or re-distribution, the number of times the content may be consumed, rendered or copied, the duration of time during which the content may be used, or the like. Some DRM systems may even include a system for tracking the usage of the digital content and for the accounting of the fees for the usage. Typically, a protected digital content is provided along with a license associated with the content. The license may be bound to, and provided together with, the digital content or may be supplied separately, and may include information regarding, e.g., one or more of the unlocking of the protective measure being employed, authentication process, and the usage rules, if any, for the digital content. In most cases, the license itself is protected in some fashion, for example, by encryption,.

A DRM agent generally is an entity that decrypts and/or authenticates the license, if necessary, deciphers and administers the usage rules, if any, and authorizes the rendering application to consume the digital content. In the case of digital distribution of the contents, there is an heightened level of the concern over the possible proliferation of illegal or otherwise unauthorized use and/or copying of the digital content because of the readily reproducible nature of digital data, which, unlike analog representation, allows repeated use and/or copies without any substantial degradation in quality over time or over many generation of copies. In large part, because of the above heightened concern, in most DRM systems, the main focus is to prevent the transfer of the digital content between multiple consumer devices, and as a result, the consumption of the digital content is typically limited to the particular single rendering application and/or to the single consumer device.

Moreover, due to the varying level of desired protection between the rights owners, and the concerns of maintaining the integrity of the DRM infrastructure, there is no one-size-fits-all DRM system, but rather there are may different DRM systems, each of which is, of a proprietary nature, developed as a result of private agreements between the content owners and/or authors on one hand and the vendors of consuming device and/or rendering applications on the other hand. As a result, each particular DRM system may use its own proprietary and different format, protocol, procedures and/or syntax in which the license may be acquired and authenticated, and in which the usage rules are defined, and thus requires a dedicated DRM agent that is specific to, and understands, the particular DRM implementation in order to use a digital content protected and supplied within that particular DRM regime. This in turn results in the rendering application being developed to include, or at least to work in conjunction with, the particular DRM agent for the particular DRM system.

The combination of the above historical partnerships between the rights owner and the supplier of the rendering application and the requirement for the consumption by a single consumer device has resulted in DRM systems that require that the consumer device, in order for the rendering application to be able to render the digital content protected under the particular DRM system, to have a built-in, or at least a tightly bound, DRM agent for the particular DRM system, residing in the same single consumer device.

An examples of contemporary DRM system may be found in the published US patent application number US2005/0198510A1 by Roberts et al. (“Roberts”), which describes the notion of domain and entity license, which could be shared by a group of consumer devices. While Roberts improves the flexibility by allowing the license to be shared, and thus the consumption of a digital content by more than one device, but Roberts system still requires that each of the consumer devices must still have the rendering application/DRM agent pair within the consumer device in order to enforce the shared license.

Another example can be found in the published international application WO 2004/019191A2 by Elazar et al. (“Elazar”), which describes a electronic book reader system, in which, in order to avoid the possible hacking by eavesdropping of a digital appliance, i.e., a personal computer, rendering of the electronic book is to be performed, not in the digital appliance, but rather in a separate DRM device that may enforce DRM protective rules and also formats or renders the electronic book before presenting the already rendered form of the electronic book to the digital appliance. The DRM device according to Elazar must therefore include a rendering application/DRM agent pair within the DRM device in order to enforce the license and to format the electronic book in compliance with the license.

From the perspective of the consumer of the content, unfortunately, the above requirement for pairing of the rendering application and the DRM agent specific to the particular DRM system being employed in a single consumer device, limits the flexibility in the manner in which the digital content may be consumed, and does not allow the consumer to use a rendering application of choice.

### SUMMARY OF THE INVENTION

According to an aspect of the present invention, a digital rights management (DRM) device is provided. The DRM device comprises an interface configured to transmit and receive one or more control messages to and from a consumer device external to the DRM device. The one or more control messages indicate at least one operation to be performed with respect to at least one of a consumption and a disposition of a protected content. The protected content is subject to a license under a digital rights management scheme. The DRM device also includes a DRM agent that communicates with the interface. The DRM agent is configured to receive, through the interface, the one or more control messages, and to determine based on the license whether the at least one operation is allowed to be performed by the external consumer device. The DRM agent is further configured to transmit a response control message, which indicates one of a first indication indicating the at least one operation is allowed and a second indication indicating the at least one operation is not permitted.

According to another aspect of the present invention a method of digital rights management (DRM) is provided. The method comprises: receiving one or more control messages from an external consumer device, the one or more control messages indicating at least one operation to be performed by the external consumer device with respect to at least one of a consumption and a disposition of a protected content stored in the external consumer device, the protected content being subject to a license under a digital right management scheme; determining based on the license whether the at least one operation is allowed to be performed by the external consumer device; and transmitting a response control message, the response control message indicating one of a first indication indicating the at least one operation is allowed and a second indication indicating the at least one operation is not permitted.

According to yet another aspect of the present invention, a method of digital rights management (DRM) is provided. The method comprises: transmitting from a first device a first control message, the first control message indicating at least one operation to be performed by the first device, the at least one operation relating to at least one of a consumption and a disposition of a protected content, the protected content being subject to a license under a digital rights management scheme; receiving at a second device the first control message; recognizing by the second device the at least one operation based on the first control message; determining by the second device, based on a content of the license, whether the at least one operation is allowed to be performed by the first device; and transmitting a second control message, the second control message including one of a first indication when the at least one operation is determined to be allowable and a second indication when the at least one operation is not to be permitted.

According to still yet another aspect of the present invention, a system for digital rights management (DRM) is provided. The system comprises: a rendering application device for transmitting a first control message, the first control message indicating at least one operation to be performed by the rendering application device, the at least one operation relating to at least one of a consumption and a disposition of a protected content, the protected content being subject to a license under a digital rights management scheme; a DRM agent device in communication with the rendering application device, the DRM agent device being configured to receive the first control message from the rendering application device, to recognize the at least one operation based on the first control message, to determine, based on the license, whether the at least one operation is allowed to be performed by the external consumer device; and to transmit a second control message, the second control message indicating one of a first indication indicating the at least one operation is allowed and a second indication indicating the at least one operation is not permitted.

Other objects, advantages, and salient features of the invention will become apparent to those skilled in the art from the following detailed description, which, taken in conjunction with the annexed drawings, discloses illustrative embodiments of the invention.

### BRIEF DESCRIPTION OF THE DRAWINGS

The above and other objects, features, and advantages of certain embodiments of the present invention will be more apparent from the following detailed description, taken in conjunction with the accompanying drawings in which:

FIG. 1 is a diagram illustrating an example exchange of control messages between a rendering application and a DRM agent;

FIG. 2 is a diagram illustrating examples of the types of control messages that can be sent from a rendering application to a DRM agent to notify the DRM agent of a content consumption operation;

FIG. 3 is a diagram illustrating an example of the process of content consumption; and

FIG. 4 is a block diagram illustrating an example configuration of a system for administering a DRM based license according to an embodiment.

Throughout the drawings, the same drawing reference numerals refer to the same or similar elements, features, and/or structures.

### DETAILED DESCRIPTION OF EMBODIMENTS

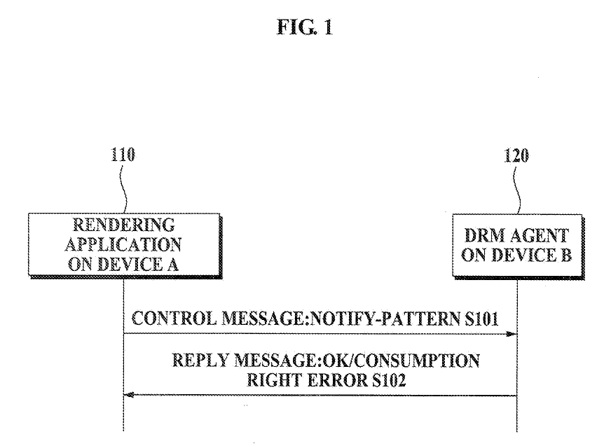

As shown in FIG. 1, according to the illustrated embodiment, a rendering application 110 runs or is disposed within a consumer device, the device A, while a DRM agent 120 is disposed within a second and separate device, the device B. The device A may be, for example, a personal computer (PC), a personal digital assistant (PDA), a mobile phone, a portable multimedia player, or the like, and may include one or more rendering applications, including at least the rendering application 110, for rendering one or more digital contents also stored within the device A. At least one of the digital content stored in the device A may be protected under the regime of a DRM system. A digital content so protected will hereafter be referred to as a protected content.

The device B may be any device in which one or more DRM agents are implemented as hardware, firmware, software, or any combination thereof, and may have its own processing capacity, e.g., a microprocessor or microcontroller, or the like, to carry out the implementation of the functions of the DRM agent or DRM agents, or in the alternative, may rely on the processing capacity of the device A when a communicative connection is made between the device A and the device B. The present embodiment contemplates the device B being a personal DRM (PDRM) possibly containing therein a plurality of DRM agents corresponding to a multitude of DRM regimes under which the device B may operate.

A communicative connection between devices A and B may be made by any device interfaces, for example, to name a few, but not limited to, interfaces that allows physical mating of the devices, e.g., a universal serial bus (USB), a serial port, parallel port, FireWire, or the like. The device B may also be implemented in a memory card device, in which case, depending on the type of the memory card device being utilized, a memory card interface, e.g., a USB interface, a Compact Flash (CF) interface, a Secure Digital Card (SD) interface, a memory stick interface, PCMCIA interface, or the like, may be employed as the interface. The interface may alternatively be a wireless interface, e.g., a Bluetooth interface, an interface according to IEEE802.11 standard, or the like. While only a few examples of the types of the device interface are listed, it should be understood that any type of interface that allows communication between the two devices can be used, and that the present invention is not limited to any one type of interface.

Referring again to FIG. 1, in step S101, after devices A and B are coupled to each other through an interface, and when the rendering application 110 needs to consume a protected content stored within the device A, the rendering application A transmits a first control message to notify the DRM agent 120 of the desired consumption operation or pattern. The rendering application 110 is not required to have any information pertaining to the usage rules under the license, nor is it required to have any information pertaining to the particular DRM regime under which the particular protected content may be authorized. The rendering application 110 can be made to determine whether the particular digital content is a protected content by for example, examining a portion of the digital content, e.g., a sufficient portion of the header information to indicate a DRM protection, which may be included in an unencrypted form for the rendering application to review, and to, based on the determination, selectively send the first message to the device B when the digital content is a protected content. In the alternative, the determination of whether the digital content is a protected content may be made by the appropriate DRM agent in the device B, in which case, the rendering application 110 may simply send the first control message whenever a digital content is about to be consumed.

The DRM agent 120 recognizes the content consumption operation about to be performed by examining the first control message, and transmits, to the rendering application 110, a second control message in step S102.

The second control message may provide an indication of whether the indicated consumption operation is one that is allowed under a license, which the DRM agent acquires and authenticates through an acquisition/authentication process, which will be described in more detail later. The DRM agent 120 transmits a second control message including, e.g., an OK response to indicate that the operations is permitted under the license, or may transmit a second control message that includes a consumption right error response when there is no valid license permitting the operation. The second control message, when the operation was found not to be permitted, may optionally include in addition to, or as a part of, the consumption right error response, a list of permitted consumption operations, if any, and/or a list of operations for which there is no permission or for which the permission under the license has either expired or been exhausted.

The rendering application 110 in response to the OK response, performs the intended consumption operation on the protected content, and thus is allowed to consume the protected content, or, if a consumption right error response was received, refrains from performing the operation. In addition, if the second message includes the optional lists, the rendering application may cease further performing of any consumption operation included in the list of expired or exhausted permissions.

As described above, the DRM agent 120 may be able to enforce DRM-related licenses, and the usage rules specified therein, through the use a simple control message exchange even when the rendering application 110 and the DRM agent 120 are implemented on separate devices. According to an aspect of the present invention, the rendering application need not have any knowledge of any of the DRM methodology being employed, and thus can be any rendering application of the consumer's choice. Moreover, depending on the type of the digital content, there may be many different consumption operations, which a rendering application can perform. In addition to the usual rendering operations, e.g., relating to the visual and/or audio presentation of the digital content, the operations may also include other types of operation relating to the disposition of the digital content, e.g., without limitation, a modification of the digital content, converting and/or saving the digital content into a different format, exporting the digital content to an external device, or the like. A DRM based license may provide rules and/or permissions relating to all or any subset of the above possible consumption and/or disposition operations.

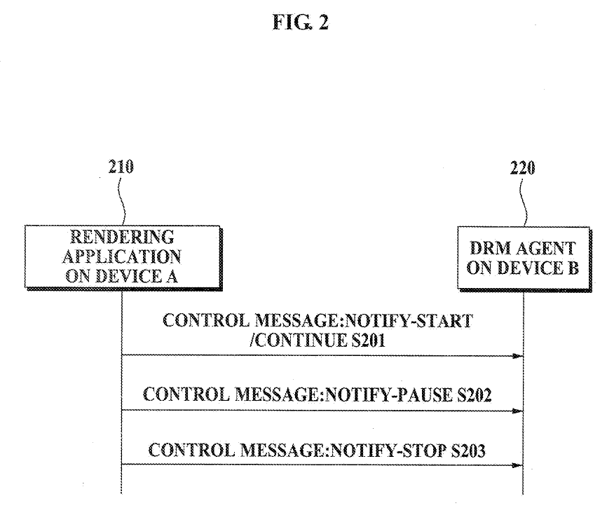

The DRM agent or agents in the device B based on the license may permit or prohibit a particular consumption operation. According to another aspect of the present invention, the control message sent from a rendering application may include messages that represent indications of the actual rendering and/or disposition operation of the digital content. In that case, the rendering application needs little or no additional operation commands other than those rendering operations the application would already ordinarily include. In order to illustrate this aspect of the invention, an example is described in reference to FIG. 2. In this example, the rendering application 210 may be a multimedia player, e.g., a video/audio player, and the digital content may be a music recording or a video clip. When the user of the consumer device A desires to listen to the music or to watch the video clip, the user rendering application 210 may initiate the rendering or the playing of the digital content.

For example, to begin the rendering, the rendering application 210 may start the playing of the digital content, and as illustrated in FIG. 2, the rendering application sends the control message to the DRM agent 220 to notify the DRM agent 220 of a content consumption operation, which is in this case the notify-start message. The notify-start message indicates the start of the digital content consumption. As can be seen from FIG. 2, the control message can also be a notify-pause message, a notify-continue message, or a notify-stop message, based on which operation the rendering may perform on the digital content.

For example, if the user of the consumer device A subsequently chose to pause the playing of the digital content, then the rendering application transmits the notify-pause message as shown in step S202.

When the consumer desires to continue the playing of the digital content from the previously paused place of the digital content, the rendering application 210 transmits to the DRAM agent 220 a notify-continue message. The notify-start and the notify-continue messages can be combined into a single message, in which case the DRM agent 220 maintains a context to distinguish whether the message indicates a start or a continuation from a previous pause.

As shown in step S203, the rendering application 210 transmits the notify-stop message to the DRM agent 220 after successful consumption of content, or at a stopping point in time of content rendering due to an error. The control messages for this example is summarized in Table 1 below.

TABLE 1

| Notification | | |
|---|---|---|
| type | Meaning | Condition |
| Notify- | Indicates either the starting on | Transmitted when a digital content |
| start/continue | resumption of content consumption. | consumption is started or when |
| message | | consumption is resumed from a |
| | | previous pause. The DRM agent |
| | | maintains a context to distinguish |
| | | between the start and resumption |
| Notify-pause | Indicates the pausing of content | Transmitted when the rendering of |
| message | consumption. | the digital content is paused. |
| Notify-stop | Indicates the stopping of content | Transmitted after a successful |
| message | consumption. The message can | consumption of content, or when the |
| | optionally include an indication | rendering has ended prematurely due |
| | relating to the status of the | to an error. |
| | consumption, e.g., whether the | |
| | consumption was successful, or the | |
| | like. | |

As previously described in reference to FIG. 1, when the DRM agent 220 receives any of the above control messages from the rendering application 210, the DRM agent 220 examines the license associated with the protected content, and determines whether the indicated consumption operation is permitted under the license. For example, the DRM agent 220 may keep track of how many times the protected content has been rendered based on the number of relevant messages received from the rendering application 210, and determine whether the current consumption is beyond the number of allowed consumption for the protected content under the license. If the number of allowed consumption has already been exhausted, preferably only taking into account of the successful consumption, then the DRM agent 220 transmits a second control message as previously described to indicate that the permission under the license has been exhausted.

The rendering application, as also described previously, will cease further consumption of the protected content in response to the second control message indicating a lack of permission. Other possible usage rules and policies, such as, for example, limited duration of use, can also similarly be enforced by the DRM agent by examining the control messages from the rendering application 210. As can be seen from this example, the enforcement of DRM based license, and the usage rules and policies therein, can be made from a DRM agent in a device that is separate from the device that renders or consumes the protected content. It can also be appreciated that the enforcement can be implemented by the use of control messages that are for the most part operations already included in the rendering application.

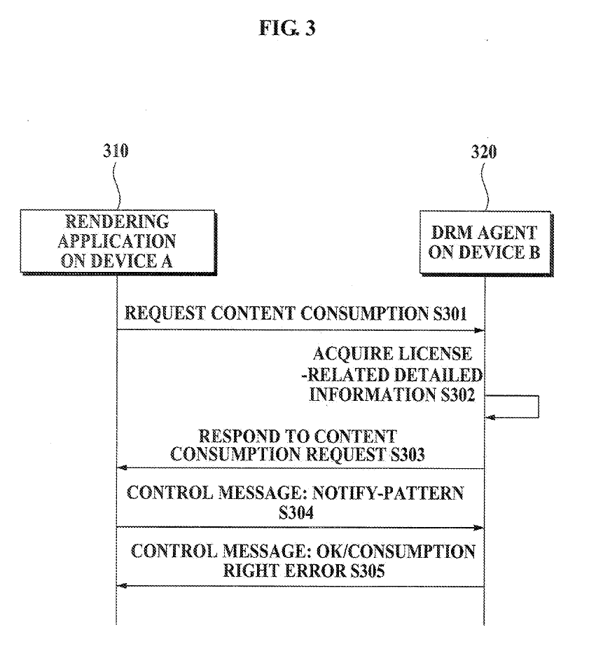

Another illustrative embodiment will be described in reference to FIG. 3, in which as with the previous examples, the rendering application 310 and the DRM agent 320 are implemented on separate devices. In this example, as shown in step S310, the rendering application 310 sends a request for permission for content consumption to the DRM agent 320 before starting a consumption operation.

In step S302, the DRM agent 320 may acquire the license associated with the protected content. The license may have been acquired beforehand, and could already be stored in the device B, in which case, the DRM agent 320 examines the license to determine if the device A and/or the rendering application 310 is authorized to consume the protected content. The content consumption request may include an information relating to the device A, such as, for example, a device ID, or any other information that uniquely identifies the device A and/or the rendering application 310.

A more elaborate process of authenticating the device A or the rendering application 310 that the above example may be dictated by the particular DRM regime involved. For example, the device A may be a part of a group of devices, sometimes referred to as a domain, and the license may authorize a domain either in addition to the device A or in lieu of the device A, in which case, the content consumption request transmitted in step S301 may include information identifying the domain to which the device A is a part. The authentication process may also involve a certification process, in which in addition to the license, a separate certificate may be required to be validated before the device A can be authorized to consume the protected content. All of the above and other possible process of authentication and/or certification are within the contemplation of this embodiment, and thus this embodiment should not be understood as being limited to any one particular authentication process.

In the event that the DRM agent 320 at the time that it received the content consumption request from the rendering application 310 did not already have the license (and/or the certificate) stored within the device B; the DRM agent 320 may acquire the license and/or the certificate associated with the protected content from a license issuer or the certificate issuer, whichever the case may be. For example, the device B may include a communication capability, i.e., an Ethernet, cellular communication, or the like, to communicate directly with the license/certificate issuers, and to negotiate on behalf of the device A to acquire and to authenticate and/or certify device A for the consumption of the protected content. In the alternative, the device B may rely on the communication capability of the device A, and thus download and authenticate the license and/or the certificate via the connection through the device A.

In step S303, based on the permissions and/or rules contained in the license, the DRM agent 320 determines whether the device A and/or the rendering application 320 is allowed to use the protected content, and responds to a content consumption request of the rendering application 310.

Once the device A is authenticated, in step S304, the rendering application 310 transmits to the DRM agent 320 a control message indicative of a consumption operation or a pattern of operations as described previously in reference to FIG. 1.

In step S305, the DRM agent 320 based on the control message received from the rendering application 310, and based on the rules and/or permissions specified in the license, sends to the rendering application 310 a response control message, which may as described previously include either an OK message permitting the operation or a consumption right error message indicating the operation cannot be permitted.

The methods that implement the aspects of the digital rights management according to the above-described embodiments may be recorded in computer-readable media including program instructions to implement various operations and functionalities described. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. Any hardware devices described above may also be configured as one or more software programs or routines in order to perform the substantially the same operations described above. Likewise, any operations and functionalities herein described may also be implemented as hardware, or a combination of hardware and software. The present invention is not limited to either a hardware or software implementation.

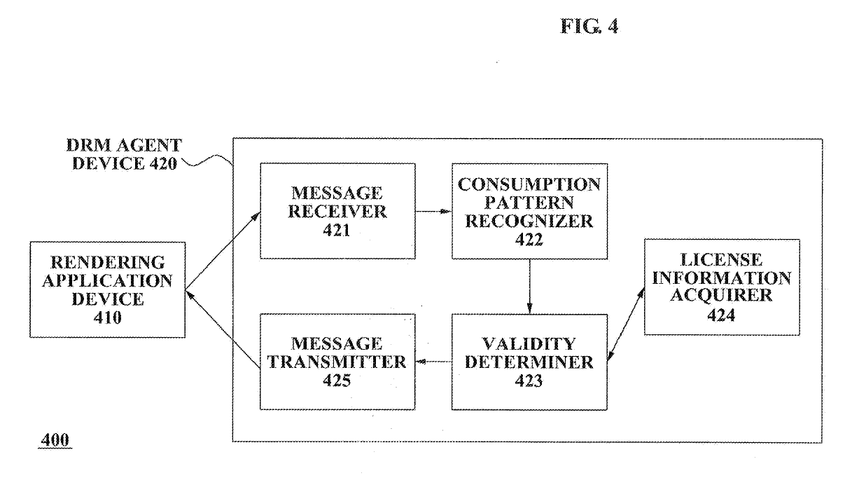

FIG. 4 illustrates a system for digital rights management of a protected content, in which the system 400 includes a rendering application device 410 and a DRM agent device 420.

The DRM agent device 420 may include a message receiver 421, a consumption pattern recognizer 422, a validity determiner 423, a license information acquirer 424, and a message transmitter 425.

The message receiver 421 receives one or more control messages from the rendering application device 410. The message transmitter 425 sends one or more control messages to the rendering application device 410. The message receiver 421 and the message transmitter 425 may be combined together to form the interface between the DRM agent device 420 and the rendering application device 410. The interface may be of the physical mating type or through a wireless communication between the device as previously discussed.

The consumption pattern recognizer 422 recognizes the consumption operation to be performed as indicated by the one or more control messages received from the rendering application device 410.

The validity determiner 423 determines whether a valid license exists for the consumed protected content, and/or whether the consumption operation as recognized by the consumption pattern recognizer 422 is permitted under the license associated with the protected content, and thus understands and/or has an access to the permissions, rules and/or policies as specified in the license.

The license information acquirer 424 acquires the license, and may be able to communicate directly to the license issuer or may communicate with the license issuer through the rendering application device 410 using the interface to the device 410 or a combination of the message receiver 421 and the message receiver 425.

As described above, although the rendering application device 410 is not required to have information relating to the DRM implementation, nor required to recognize the particular DRM regime under which the protected content is protected, the DRM agent device 420, which is separate from the rendering application device 410, can administer the DRM permission, rules and constraints by the exchange of simple control message(s). While for the purpose of illustration various functional components are shown as separate functional blocks in FIG. 4, it should be understood that any, some or all of the illustrated blocks can be implemented as a single component. It should be also understood that any of the functional blocks shown can be implemented as any of a software module, as a hardware component, and as a combination of software modules and hardware components.

While the invention has shown and described with reference to certain embodiments thereof, it will be understood by those skilled in the art that various changes in form and details may be made therein without departing from the spirit and scope of the present invention as defined by the appended claims and their equivalents.

What is claimed is:

1. A digital rights management (DRM) device, comprising:
an interface configured to receive one or more control messages from an external consumer device, said one or more control messages indicating at least one operation to be performed with respect to at least one of a consumption and a disposition of a protected content, said protected content being subject to a license under a digital rights management scheme; and
a DRM agent in communication with said interface, said DRM agent being configured to receive from said interface said one or more control messages, and to determine based on said license whether said at least one operation is allowed to be performed by said external consumer device, said DRM agent being further configured to transmit a response control message to said interface, said response control message indicating one of a first indication indicating said at least one operation is allowed and a second indication indicating said at least one operation is not permitted.

2. The digital rights management (DRM) device according to claim 1, wherein:
said DRM agent comprises at least one of a microprocessor and a microcontroller.

3. The digital rights management (DRM) device according to claim 1, further comprising:
a second interface configured to communicate with a communication network, wherein said DRM agent is further configured to acquire said license associated with said protected content from said communication network through said second interface.

4. The digital rights management (DRM) device according to claim 1, wherein said one or more control messages comprise at least one of a notify-start message, a notify-continue message, a notify-pause message and a notify-stop message, wherein said at least one of said consumption and said disposition comprises a rendering of said protecting content within said external consumer device, and wherein:
said notify-start message indicates a beginning of said rendering of said protected content;
said notify-continue message indicating a resumption of said rendering of said protected content;
said notify-pause message indicates a temporarily pausing of said rendering of said protected content; and
said notify-stop message indicates a terminating of said rendering of said protected content.

5. The digital rights management (DRM) device according to claim 1, wherein said at least one operation relates to said disposition of said protected content, said at least one operation comprising:
at least one of an exportation of said protected content to a second consumer device external to said external consumer device, a modification of said protected content, and a storing of a modified version of said protected content within said external consumer device.

6. A method of digital rights management (DRM), comprising:
receiving one or more control messages from an external consumer device, said one or more control messages indicating at least one operation to be performed by said external consumer device with respect to at least one of a consumption and a disposition of a protected content stored in said external consumer device, said protected content being subject to a license under a digital right management scheme;
determining based on said license whether said at least one operation is allowed to be performed by said external consumer device; and
transmitting a response control message, said response control message indicating one of a first indication indicating said at least one operation is allowed and a second indication indicating said at least one operation is not permitted.

7. The method of digital rights management (DRM) as set forth in claim 6, wherein said one or more control messages comprise at least one of a notify-start message, a notify-continue message, a notify-pause message and a notify-stop message, wherein said at least one of said consumption and said disposition comprises a rendering of said protecting content within said external consumer device, and wherein:
said notify-start message indicates a beginning of said rendering of said protected content;
said notify-continue message indicating a resumption of said rendering of said protected content;
said notify-pause message indicates a temporarily pausing of said rendering of said protected content; and
said notify-stop message indicates a terminating of said rendering of said protected content.

8. The method of digital rights management (DRM) as set forth in claim 6, further comprising:
acquiring said license from a license issuer for said protected content; and
storing internally said acquired license.

9. The method of digital rights management (DRM) as set forth in claim 6, wherein said at least one operation relates to said disposition of said protected content, said at least one operation comprising:
at least one of an exportation of said protected content to a second consumer device external to said external consumer device, a modification of said protected content, and a storing of a modified version of said protected content within said external consumer device.

10. A method of digital rights management (DRM), comprising:
transmitting, from a first device, a first control message, said first control message indicating at least one operation to be performed by said first device, said at least one operation relating to at least one of a consumption and a disposition of a protected content, said protected content being subject to a license under a digital rights management scheme;
receiving, by a second device, said first control message;
recognizing, by said second device, said at least one operation based on said first control message;
determining, by said second device, based on a content of said license, whether said at least one operation is allowed to be performed by said first device; and
transmitting, by said second device, a second control message, said second control message including one of a first indication when said at least one operation is determined to be allowable and a second indication when said at least one operation is not to be permitted.

11. The method of digital rights management (DRM) as set forth in claim 10, further comprising:
receiving by said first device said second control message;
performing said at least one operation by said first device if said second control message includes said first indication; and
refraining by said first device from performing said at least one operation if said second control message includes said second indication.

12. The method of digital rights management (DRM) as set forth in claim 10, wherein the first control message comprises at least one of a notify-start message, a notify-pause message, a notify-continue message, and a notify-stop message, wherein:
said notify-start message indicates a beginning of said rendering of said protected content;
said notify-continue message indicating a resumption of said rendering of said protected content;
said notify-pause message indicates a temporarily pausing of said rendering of said protected content; and
said notify-stop message indicates a terminating of said rendering of said protected content.

13. The method of digital rights management (DRM) as set forth in claim 10, wherein said first device includes a rendering application program for rendering said protected content, said rendering application possessing no information relating to particularities of said digital rights management scheme.

14. The method of digital rights management (DRM) as set forth in claim 10, wherein said second control message further comprises a listing of one or more consumption operations, for which a usage permission has either expired or exhausted, said method further comprising:
refraining by said first device from performing any of said one or more consumption operations included in said listing.

15. The method of digital rights management (DRM) as set forth in claim 10, wherein said first control message is transmitted at least once each time said protected content is consumed.

16. A computer-readable recording medium having stored thereon a program for implementing a digital rights management, said program comprising one or more instructions for:
receiving one or more control messages from an external consumer device, said one or more control messages indicating at least one operation to be performed by said external consumer device with respect to at least one of a consumption and a disposition of a protected content stored in said external consumer device, said protected content being subject to a license under a digital right management scheme;
determining based on said license whether said at least one operation is allowed to be performed by said external consumer device; and
transmitting a response control message, said response control message indicating one of a first indication indicating said at least one operation is allowed and a second indication indicating said at least one operation is not permitted.

17. A system for digital rights management (DRM), comprising:
a rendering application device for transmitting a first control message, said first control message indicating at least one operation to be performed by said rendering application device, said at least one operation relating to at least one of a consumption and a disposition of a protected content, said protected content being subject to a license under a digital rights management scheme;
a DRM agent device in communication with said rendering application device, said DRM agent device being configured to receive said first control message from said rendering application device, to recognize said at least one operation based on said first control message, to determine, based on said license, whether said at least one operation is allowed to be performed by said external consumer device; and to transmit a second control message, said second control message indicating one of a first indication indicating said at least one operation is allowed and a second indication indicating said at least one operation is not permitted.

18. The system for digital rights management (DRM) according to claim 17, wherein said DRM agent device comprises:
a message receiver for receiving said first control message;
a consumption pattern recognizer for recognizing said at least one operation based on said first control message;
a validity determiner for determining whether said license includes a valid permission for said at least one operation; and
a message transmitter for transmitting, to said rendering application device, said second control message.

19. The system for digital rights management (DRM) according to claim 17, wherein said second control message further comprises a listing of expired or exhausted permissions, and wherein:
said rendering application device is further configured to refrain from performing any consumption operations included in said listing.

20. The system for digital rights management (DRM) according to claim 17, further comprising;
a license information acquirer for acquiring said license from a license issuer assigned by said digital rights management scheme,
wherein said validity determiner is further configured to determine whether said rendering application device is authorized to consume said protected content under said license acquired by said license information acquirer.

21. The system for digital rights management (DRM) according to claim 17, wherein said first control message comprises at least one of a notify-start message, a notify-pause message, a notify-continue message, and a notify-stop message.
